(19) United States
(12) Patent Application Publication
(10) Pub. No.: US 2023/0159383 A1
(43) Pub. Date: May 25, 2023

(54) SHEET-LIKE GLASS ARTICLE, METHOD FOR PRODUCING SAME, AND USE THEREOF

(71) Applicants: SCHOTT AG, Mainz (DE); SCHOTT Technical Glass Solutions GmbH, Jena (DE)

(72) Inventors: Sebastian Leukel, Mainz (DE); Jacqueline Engelmann, Mainz (DE)

(73) Assignees: SCHOTT AG, Mainz (DE); SCHOTT Technical Glass Solutions GmbH, Jena (DE)

(21) Appl. No.: 18/057,381

(22) Filed: Nov. 21, 2022

(30) Foreign Application Priority Data
Nov. 19, 2021 (DE) 10 2021 130 331.1

(51) Int. Cl. C03C 21/00; C03C 4/10; C03C 3/085

(52) U.S. Cl. CPC C03C 21/002; C03C 4/10; C03C 3/085; C03C 2201/40; C03C 2201/50; C03C 2203/50

(57) ABSTRACT

A chemically toughenable or toughened sheet-like glass article is provided. The article has a glass with a composition comprising Al₂O₃, SiO₂, Li₂O, and Na₂O, wherein (Al₂O₃)−(Li₂O+Na₂O), in mol %, is less than 0; a thickness between 0.3 mm and 4 mm; a light transmittance of at least 0.001% to at most 60% at 450 nm, of at least 0.001% to at most 30% at 540 nm, and of at least 0.001% to at most 30% at 630 nm; and an IR transmittance of at least 10% to not more than 99% at any wavelength in a wavelength range from 900 nm to 1100 nm. The light and IR transmittances are determined for a thickness of the article of 1 mm.

### CROSS REFERENCE TO RELATED APPLICATIONS

This application claims benefit under 35 USC § 119 of German Application 10 2021 130 331.1 filed Nov. 19, 2021, the entire contents of which are incorporated herein by reference.

### BACKGROUND

### 1. Field of the Invention

The present invention generally relates to a sheet-like glass article, namely a chemically toughenable or a chemically toughened sheet-like glass article, which is used or can be used in particular as a back cover sheet for mobile devices. Furthermore, the present invention relates to a method for producing such a glass article, to glass articles obtained by this method, and to the use of such glass articles.

### 2. Description of Related Art

Currently, transparent chemically toughened glasses with printing on the back, colored plastics materials, metals or ceramics are used as a back cover for mobile devices.

The known solutions have a number of advantages, but each also has specific drawbacks.

Plastics materials, for example, are cheap and offer a wide range of options in terms of shape and color, but have drawbacks in terms of haptics and mechanical durability, especially scratch resistance, compared to the other materials.

Metallic back covers prevent the possibility of inductive charging of mobile devices, make it more difficult to use antennas and are usually associated with significantly higher costs.

Ceramics are in fact very hard, but they are expensive to produce and tend to brittle fracture. Also, they are difficult to process, which reduces design freedom.

Compared thereto, transparent chemically toughened glass or a glass article made from this material has a number of advantages. For example, such a glass article exhibits good mechanical resistance under relevant loads. Inductive charging is also possible in this way. Antennas can also be integrated. Moreover, such a glass article can also be shaped relatively flexibly, so that curved or more generally three-dimensionally shaped glass articles can also be produced easily.

However, colored back coverings in the domain of such chemically toughened glass articles are only obtained by printing on the back of the glass article, or by colored coatings, or by colored foils. However, the overall visual appearance of a volume-colored, i.e., bulk-tinted glass article cannot be achieved in this way. In particular a black color appearance is not possible in this way. This is because the actually transparent glass material reflects too much light.

U.S. patent application US 2011/0071012 A1 discloses a dark-colored chemically toughenable glass comprising between 50 and 75 mol % of SiO₂, 1 to 15 mol % of Al₂O₃, 6 to 21 mol % of Na₂O, and, as optional constituents, up to 15 mol % of K₂O, up to 15 mol % of MgO, up to 20 mol % of CaO, and up to 21 mol % of RO (R being Mg, Ca, Sr, Na, and/or Zn), up to 5 mol % of ZrO₂, between 1.5 and 6 mol % of Fe₂O₃, and between 0.1 and 1 mol % of Co₃O₄. Further constituents may also be included.

However, such a glass does not provide for a mechanically stable back cover but to a very limited extent. A statement about IR transmittance is not included.

There is therefore a need for a glass article that combines the advantages of chemical toughening with bulk tinting. This means in particular that the transmittance in the visible has to be reduced significantly. However, it would be advantageous if the glass or the glass article is designed so as to still exhibit sufficient IR transmittance to enable melting of the glass and hot forming. Furthermore, the color-imparting constituents must not have any adverse impact on the chemical toughening process. In order to accommodate the mechanical stresses a back cover or back cover sheet might experience, it is particularly advantageous to design the glass of the glass article in such a way that a combined prestress profile is obtained, including sodium prestress which is particularly good for the resistance of a glass article when exposed to what is known as “sharp impact” loads, and a high potassium prestress, i.e., a high prestress on the surface of the glass article for high flexural strength (or flexural tensile strength). However, such glasses or glass articles made from such glasses have not yet been known.

### SUMMARY

The object of the invention is to provide a glass article which at least partially mitigates the aforementioned deficiencies of the prior art. Further aspects of the invention relate to the provision of a glass composition which permits to produce such glass articles, and to a method for producing such glass articles, as well as to glass articles obtained by such method. Yet another aspect is directed to the use of such glass articles according to embodiments of the disclosure.

The invention accordingly relates to a chemically toughenable or chemically toughened sheet-like glass article for use as a back cover sheet for mobile devices. The glass article comprises a glass having a composition comprising Al₂O₃, SiO₂, Li₂O, Na₂O, and optionally K₂O and/or B₂O₃, wherein (Al₂O₃+B₂O₃)−(Li₂O+Na₂O+K₂O), all in mol %, is less than 0, which has a thickness of 0.3 mm to 4 mm,

and which exhibits a light transmittance τ of at most 60% at 450 nm, of at most 30% at 540 nm, and of at most 30% at 630 nm, with a respective lower limit of preferably at least 0.001%, more preferably at least 0.01%, most preferably at least 0.1%,

and which exhibits an IR transmittance of at least 10% at any wavelength in a wavelength range from 900 nm to 1100 nm, wherein the transmittance preferably is not more than 99% in each case,

which transmittance values are determined for a thickness of the sheet-like glass article of 1 mm in each case.

The composition of the glass preferably comprises at least 0.1 mol % and at most 5 mol % of at least one color-imparting component, in particular preferably selected from the group consisting of CoO, Fe₂O₃, TiO₂, Cr₂O₃, and/or MnO, and/or of mixtures thereof.

Such a design has a number of advantages.

A chemically toughenable sheet-like glass article for use as a back cover sheet is generally understood to mean a chemically toughenable sheet-like glass article for producing a chemically toughened glass article to be used as a back cover sheet. Such a back or rear cover sheet is often also referred to as a “back cover”, for short.

Thus, the present disclosure in particular also encompasses a chemically toughenable glass article for producing a chemically toughened glass article according to embodiments.

A sheet-like glass article is generally understood to mean that the spatial dimensions of the glass article in one spatial direction of a Cartesian coordinate system are at least one order of magnitude smaller than in the two other spatial directions perpendicular to the first spatial direction. In other words, the thickness of a sheet-like glass article is at least one order of magnitude less than the length and width thereof. The sheet-like glass article may generally be flat, but may also be curved or deformed, for example in the form of a curved or bent sheet.

The glass the glass article is made of has a composition comprising Al₂O₃, SiO₂, Li₂O, Na₂O, and optionally K₂O and/or B₂O₃, wherein (Al₂O₃+B₂O₃)−(Li₂O+Na₂O+K₂O) is less than 0, by mol % in each case. In other words, this means that the glass of the glass article is designed so that it can be chemically toughened in such a way that a combined prestress can be achieved, i.e., a replacement of sodium ions by potassium ions is possible for a high prestress value on the surface of the toughened glass article in combination with a sodium prestress achieved by replacing lithium ions by sodium ions.

Therefore, advantageously, it may be intended for the glass and/or the glass article to generally comprise Li₂O, for example at least 7 mol % (based on an oxide basis), for example 7 mol % to 12 mol %, preferably 7 mol % to 11 mol %.

More generally, it may be intended for the glass and/or the glass article to generally comprises or to be made of a lithium aluminum silicate glass. This means that the glass and/or the glass article comprises SiO₂, Al₂O₃, and Li₂O as constituents.

According to one embodiment, the glass or glass article may generally comprise, in mol percent on an oxide basis:

| | |
|---|---|
| SiO₂ | 60 to 70, preferably 62 to 69, more preferably 63 to 69, |
| | most preferably 63 to 68, |
| Al₂O₃ | 10 to 15, preferably 10 to 13, |
| Li₂O | 7 to 12, preferably 7 to 11. |

Furthermore, the glass may also comprise Na₂O according to one embodiment, preferably at least 0.5 wt % thereof, and advantageously preferably not more than 11 mol %. According to one embodiment, a content of Na₂O between 1 mol % and 10 mol % is particularly preferred.

The aforementioned embodiments are suitable for providing a glass that can chemically toughened in a particularly simple manner, and more generally for providing a glass article that is readily chemically toughenable.

At the same time, the aforementioned embodiments of the glass or glass article surprisingly allow to adjust different transmittance spectra, depending on the desired product performance. In other words, it is possible to add different colorants to a respective base glass (here meaning a glass composition without the respective additives for adjusting the color tint). Hence, the aforementioned base glasses are not only easy to strengthen chemically, but are in particular chemically stable enough so that different colorants can be added without inducing devitrification.

Another advantage is that chemical toughening processes do not have to be adapted for such glass compositions.

Furthermore, the thickness between 0.3 mm and 4 mm is chosen such that a good tradeoff is found between a low weight of the back cover (or rear cover sheet) and its mechanical stability. Thinner glass articles do not exhibit sufficient mechanical resistance. Thicker sheets, on the other hand, are too heavy.

Furthermore, the composition of the glass of the glass article is chosen so that the base glasses are rich in alkali and allow to integrate color-imparting oxides, for example cobalt oxide CoO, so that adequate coloring of the glass and, accordingly, of the glass article is made possible in the visible spectral range, and at the same time adequate transmittance in the near IR range is also ensured. Hence, the structure of the glasses defined herein is such that color-imparting oxides can be incorporated into the glass structure, while at the same time good IR transmittance of the base glass is retained. Advantageously, this can be achieved by having the constituents of the glass satisfying the above conditions, namely that (Al₂O₃+B₂O₃)−(Li₂O+Na₂O+K₂O) is less than zero. In fact, it has been found that alkali-rich glasses are necessary to ensure sufficient IR transmittance, while it is not the alkali content (i.e., the total of the components Li₂O, Na₂O, and K₂O) of the glass alone which is the decisive factor, but rather the ratio (Al₂O₃+B₂O₃)−(Li₂O+Na₂O+K₂O) (all data in mol %) has to be considered. In fact, it has been found that high levels of alkalis or alkali oxides prevent the precipitation of strongly colored and IR-blocking crystallites, such as ilmenite FeTiO₃.

More particularly, it has generally been found that the relation to the total of Al₂O₃+B₂O₃ is essential, since Al₂O₃ and B₂O₃ compensate for the separation points formed in the glass structure by alkali oxides, and therefore also have to be taken into account when considering the properties implied by alkali oxides. Hence, the general composition defined here, namely comprising Al₂O₃, SiO₂, Li₂O, Na₂O, and optionally K₂O and/or B₂O₃, with (Al₂O₃+B₂O₃)−(Li₂O+Na₂O+K₂O) being less than 0, all in mol %, describes the glasses which allow to achieve the required properties in terms of optics, but also in mechanical terms.

In this case, the optical properties will then advantageously be adjusted such that light transmittance τ is not more than 60% at 450 nm, not more than 30% at 540 nm, and not more than 30% at 630 nm, with a respective lower limit of preferably at least 0.001%, more preferably at least 0.01%, most preferably at least 0.1%. However, at individual wavelengths and/or over a particular wavelength range in the visible wavelength range, in particular at wavelengths in the range between 390 nm and 630 nm, for example between 390 nm and 460 nm, and/or between 450 nm and 630 nm, spectral transmittance may even be 0 within the scope of measurement accuracy, in particular in the case of the exemplary sample thicknesses of 1 mm considered here. For example, this is the case with the exemplary glasses 1 and 3 of FIG. 2. At the same time, IR transmittance is at least 10% at any wavelength in a wavelength range from 900 nm to 1100 nm, and the transmittance is preferably at most 99% in each case. These values have to be understood as reference values here, i.e., determined for a thickness of the sheet-like glass article of 1 mm in each case.

Here, light transmittance or transmittance at a specific wavelength is generally understood to mean spectral transmittance, i.e., the transmittance value measured at a specific wavelength.

In order to verify whether the optical properties are met, thicker sheet-like glass articles can be thinned out, and thinner glass articles can be stacked to obtain the respective thickness and then measured.

According to one embodiment, the transmittance values can be achieved in a particularly simple manner by having at least 0.1 mol % and at most 5 mol % of at least one color-imparting component contained in the composition of the glass and/or the glass article, most preferably selected from the group consisting of CoO, Fe₂O₃, TiO₂, Cr₂O₃, and/or MnO, and/or of mixtures thereof.

In this case, the base glass and the at least one color-imparting component are matched to one another in such a way that the low light transmittance values in the visible spectral range are combined with sufficiently high IR transmittance.

This has not been known so far. It is precisely the combination of certain alkali contents in combination with the contents of the oxides Al₂O₃ and B₂O₃ and a color-imparting oxide which, according to one embodiment, surprisingly allow to achieve the advantageous optical properties of a volume-colored, i.e., bulk-tinted, glass article that is provided in chemically toughened form or can be chemically toughened. In this case, the glass is composed in such a way that very advantageous prestress profiles can be achieved, in particular “combined” prestress profiles, i.e., comprising a “potassium” component and a “sodium” component.

The high IR transmittance of the glassy material is particularly advantageous in the colored glass articles or glasses according to embodiments. In the manufacturing process, especially during the melting process, this offers the advantage that the thermal energy required for melting can be introduced into the glass, but can also be released again. This is difficult with known dark glasses or glassy materials.

The amounts of the color-imparting oxides, for example of the constituents cobalt oxide, iron oxide, chromium oxide, manganese oxide, are always specified as an oxide with a specific oxidation state throughout the present disclosure. For example, the constituents cobalt oxide, iron oxide, chromium oxide, and manganese oxide are always given as CoO, Fe₂O₃, Cr₂O₃, and MnO. However, their cations may also be present in other oxidation numbers. If, for example, CoO is mentioned here as the color-imparting component, this is generally understood to mean that the cobalt ion may also be present in an oxidation state other than the divalent positive one, for example as the trivalent positive ion Co³⁺ These statements similarly apply to the other color-imparting constituents. Color-imparting oxides or, more generally, color-imparting constituents are also understood to mean those which do not have a color-imparting effect alone, but in conjunction with a further component.

For example, possible oxidation states of cobalt are +2 and +3, for iron +2 and +3, for chromium +3, and for manganese +2, +3, and +4. The higher the maximum temperature in the manufacturing process, the more likely it is that lower oxidation states will dominate. In addition, the proportion of reduced species can be shifted by adding reducing agents such as carbon or sugar into the glass melt. Generally, in the glasses described, transmittance in the visible decreases due to a higher proportion of reduced species. The spectral transmittance values given in the present disclosure in combination with the respective compositions refer to glasses that were melted without reducing agents and with the maximum temperature required for refining (approx. the T2 temperature of the glass; 1500-1650° C.).

As far as reference is made to a glass and/or a glass article which comprises CoO as the color-imparting component or color-imparting constituent within the context of the present disclosure, this can also be understood to mean that the glass or the glass article is doped with CoO or with cobalt. These statements similarly apply to the other color-imparting constituents.

Within the context of the present disclosure, the color-imparting component may synonymously also be referred to as a dye or a colorant.

TiO₂ is not a color-imparting component per se, but in combination with Fe₂O₃ it supports the coloring caused by Fe₂O₃ by forming colored FeTiO₃ complexes in the glass.

According to one embodiment of the glass article, the latter is distinguished by the fact that the glass and/or the glass article contains 0.1 mol % to 2 mol %, preferably 0.3 mol % to 1.5 mol % of CoO, and exhibits a light transmittance τ of at least 20% and at most 60% at 450 nm, at most 20% at 540 nm, and at most 20% at 630 nm, and an IR transmittance of at least 20% in a wavelength range from 900 nm to 1100 nm, with the transmittance values being determined for a thickness of the sheet-like glass article of 1 mm in each case.

One embodiment of the glass article in a form where the latter or the glass this glass article is made from includes CoO as the color-imparting component results in a color appearance of a translucent strong blue. Such a glass article is therefore particularly suitable as a back cover for blue LEDs.

According to a further embodiment, the glass article is distinguished by the fact that the glass and/or the glass article contains 0.5 mol % to 5 mol % of Fe₂O₃, preferably 1.5 mol % to 4 mol % of Fe₂O₃, and 0.5 mol % to 3 mol % of TiO₂, preferably 1 mol % to 2.5 mol % of TiO₂, and exhibits a light transmittance τ of at most 20% at 450 nm, at most 30% at 540 nm, and at most 30% at 630 nm, and exhibits an IR transmittance of at least 10% in a wavelength range from 900 nm to 1100 nm, the transmittance preferably being not more than 99% in each case, with the transmittance values being determined for a thickness of the sheet-like glass article of 1 mm in each case.

In this way, a translucent strong black or a very dark brown can be obtained.

According to a particularly preferred embodiment it is possible in this case to adjust the color appearance through a particular amount of CoO such that, additionally, a blue tint can be achieved.

According to yet another embodiment, the sheet-like glass article is distinguished by the fact that the glass and/or the glass article contains 0.1 mol % to 1 mol % of Cr₂O₃, preferably 0.2 mol % to 0.6 mol % of Cr₂O₃, and 0.5 mol % to 4 mol % of MnO, preferably 1 mol % to 3 mol % of MnO, and exhibits a light transmittance τ of at most 10% at 450 nm, at most 20% at 540 nm, and of at most 30% at 630 nm, and exhibits an IR transmittance of at least 10% in a wavelength range from 900 nm to 1100 nm, with the transmittance values being determined for a thickness of the sheet-like glass article of 1 mm in each case.

In this way, a very dark brown to an almost opaque deep black can be obtained, depending on how high the content of the color-imparting component is. The higher the content of the color-imparting component, the blacker or darker the glass article will appear.

The color appearances described generally relate to sheet-like glass articles with typical thicknesses in the millimeter range.

The mechanical requirements, for example in terms of hardness and impact resistance, which are placed on a glass article that is to be used as a back cover, are generally comparable to those of a glass article that is to be used as a front cover. In fact, the loads tend to be slightly different. For example, breakage or scratches on a front cover will more quickly lead to functional limitations in normal use, but back covers are often designed with a slightly lower thickness, which means that a glass would have to provide more for the same performance (back covers usually about 0.5-0.6 mm, front covers mostly about 0.6-0.8 mm). Furthermore, the translucent variations of the glass article according to embodiments can moreover offer the ability to allow smaller rear displays to shine through. The glass article according to embodiments should therefore generally provide a comparable mechanical performance to glass articles intended for use as a front cover. Therefore, advantageously, the glass article is chemically toughened.

According to one embodiment, the glass article in its toughened state preferably exhibits a compressive stress CS at the surface of at least 200 MPa to at most 1100 MPa, a compressive stress at a depth of 30 μm, CS30, of at least 50 MPa up to 300 MPa, and a depth of compressive layer, DoCL, between 0.05*t and 0.3*t, where t is the thickness of the sheet-like glass article in μm.

Preferably, the glass article generally has a thickness of at least 0.3 mm, more preferably at least 0.5 mm, and/or of at most 2.5 mm and preferably not more than 2 mm.

Typical thicknesses for glass articles intended for use as back covers are between 0.5 mm and 0.6 mm, although special designs with large-area mechanical ablation, for example in order to achieve a homogeneous transition between a raised camera area and the rest of the back cover, may even require thicknesses between 1 mm and 2 mm.

Moreover, other applications are conceivable, for example in the field of wearables, or applications for which thicknesses of even more than 2 mm are considered, such as applications in the field of cooking on glass. From a general design point of view, without being limited to a specific embodiment, it is especially a variation in thickness in a glass article that can provide particularly desired effects, since the thickness-dependent transmittance provides for varying color intensities. It is also conceivable to integrate a rear display over the entire rear surface or in a section thereof behind the back cover which can be prepared to a thickness of less than 0.5 mm in this case in order to improve visibility but still retain its color appearance in the switched-off state. This is in particular conceivable in the case of foldable smartphones in which the back cover also functions as a front cover in the folded state.

According to one embodiment of the glass article, the latter is designed such that the glass article and/or the glass the glass article is made of comprises the following constituents, in mol % on an oxide basis:

| | |
|---|---|
| SiO₂ | 60 to 70, preferably 62 to 69, more preferably 63 to 69, most |
| | preferably 63 to 68, |
| B₂O₃ | 0 to 7, preferably 0 to 5, more preferably 0 to 4, most preferably |
| | 0 to 1, wherein, preferably, B₂O₃ is not contained at all apart |
| | from impurities, |
| Al₂O₃ | 10 to 15, preferably 10 to 13, |
| Li₂O | 7 to 12, preferably 7 to 11, |
| Na₂O | 0.5 to 11, preferably 1 to 10, |
| K₂O | 0 to 1, |
| MgO | 0 to 5, |
| P₂O₅ | 0 to 3, preferably 0 to 2, most preferably at least 0.2, |
| ZrO₂ | 0 to 5. |

Depending on the precise design of the glass article, the glass and/or the glass article may include further constituents.

Preferably, the composition of the glass and/or of the glass article generally comprises at least 0.1 mol % and not more than 5 mol % of at least one color-imparting constituent, in particular preferably selected from the group consisting of CoO, Fe₂O₃, TiO₂, Cr₂O₃, and/or MnO, and/or of mixtures thereof.

According to a further aspect, the present disclosure also relates to a glass. The glass comprises the following constituents, in mol % on an oxide basis:

| | |
|---|---|
| SiO₂ | 60 to 70, preferably 62 to 69, more preferably 63 to 69, most |
| | preferably 63 to 68, |
| B₂O₃ | 0 to 7, preferably 0 to 5, more preferably 0 to 4, most preferably |
| | 0 to 1, wherein, preferably, B₂O₃ is not contained at all apart |
| | from impurities, |
| Al₂O₃ | 10 to 15, preferably 10 to 13, |
| Li₂O | 7 to 12, preferably 7 to 11, |
| Na₂O | 0.5 to 11, preferably 1 to 10, |
| K₂O | 0 to 1, |
| MgO | 0 to 5, |
| P₂O₅ | 0 to 3, preferably 0 to 2, most preferably at least 0.2, |
| ZrO₂ | 0 to 5. |

Preferably, the composition of the glass generally comprises at least 0.1 mol % and not more than 5 mol % of at least one color-imparting constituent, in particular preferably selected from the group consisting of CoO, Fe₂O₃, TiO₂, Cr₂O₃, and/or MnO, and/or of mixtures thereof.

Another aspect of the present disclosure also relates to the use of a glass article according to embodiments as a back cover sheet, in particular as a cover sheet for consumer electronics devices, in particular for display devices, screens of computer devices, measurement devices, TV sets, in particular as a cover sheet for mobile devices, in particular for at least one device selected from the group consisting of: mobile terminals, mobile data processing devices, in particular mobile phones, mobile computers, palmtops, laptops, tablet computers, wearables, wearable watches, and time measuring devices.

Furthermore, it is also possible to use the glass article as a cover sheet in the field of cooking on glass.

Depending on the exact use, many different designs of the glass article are generally possible.

According to one embodiment, if a glass article and/or the glass the glass article is made of is doped with iron and/or titanium and/or cobalt, it is conceivable to use this glass article as a back cover in a smartphone in combination with underlying design elements such as foils or prints with color gradients and/or with shimmering effects that shine through the glass article. The inherent coloring of the glass or glass article in combination with the underlying design elements and the light that is incident on the glass article creates special design effects.

According to a further embodiment, it is also conceivable to use a translucent glass article doped with iron and/or titanium and/or cobalt as a back cover in a foldable smartphone, which makes it possible to let shine through digital displays that are placed behind the glass, while they will disappear when switched off.

According to a further embodiment, a glass article is used as a back cover, which is doped with chromium and manganese and which contains a content of colorants in the medium to upper range preferred for Cr₂O₃ and MnO, i.e., between 0.2 mol % and 0.6 mol % of Cr₂O₃, and between 1 mol % and 3 mol % of MnO. This is advantageous because it exhibits only low spectral transmittance in the visible range. This means that a covering coating on the back can be dispensed with. Still, however, a deep dark appearance of the glass or glass article can be achieved, due to the inherent coloring. The visibility of device components behind the glass article will be prevented solely by the strong bulk tinting of the glass or glass article in this case.

However, it may also be advantageous to use a glass article as the back cover, which comprises a glass doped with iron, titanium and cobalt. In this case, between 0.1 mol % and 1 mol % of CoO is added to the Fe—Ti-colored glass. This allows to vary the color appearance of the glass article between black and a dark blue, depending on the color tint of the background.

By way of example, the table below lists such composition ranges (given in mol % on an oxide basis) in which contents of respective colorants can be added for such a variation of the color appearance of a glass composition according to embodiments as described above:

| Range | a) | b) | c) | d) |
|---|---|---|---|---|
| Fe₂O₃ | 0.5-2; | 1.4-5; | 0.5-2; | 1.4-5; |
| | preferably | preferably | preferably | preferably |
| | 0.5-1.4 | 2-5 | 0.5-1.4 | 2-5 |
| TiO₂ | 0.5-1.2 | 1.2-2.5 | 0.5-1.2 | 1.2-2.5 |
| CoO | −0.3; | −0.3; | 0.25-1; | 0.25-1; |
| | preferably | preferably | preferably | preferably |
| | 0.1-0.25 | 0.1-0.25 | 0.3-1 | 0.3-1 |
| Color | black-blue | black | dark blue | black with blue |
| appearance | translucent | | | tint |

This means that different design options are obtained with the same glass composition. The more CoO is added to the glass, the more intense the blue impression will be. For example, against a white or light-colored background, the glass or glass article with a thickness that is typical for back cover applications as described above may appear bluish, while the same article will appear jet black against a dark background.

Further variations are possible, so that a wide variety of detailed solutions can be adjusted depending on the exact application.

The advantage here is that all these detailed solutions have in common the design aspects mentioned above in combination with the good mechanical properties of high-quality LAS cover glasses.

Yet another aspect relates to a method of producing a toughened glass article according to an embodiment of the disclosure, comprising the steps of: performing an ion exchange in the glass article in an exchange bath that comprises between at least 10 wt % and up to 100 wt % of a sodium salt, preferably sodium nitrate NaNO₃, over a duration of at least 2 hours, preferably at least 4 hours, and not more than 24 hours, at a temperature between at least 380° C. and at most 440° C., wherein optionally a potassium salt can be added to the exchange bath, in particular potassium nitrate KNO₃, in particular such that the total contents of sodium salt and potassium salt add up to 100 wt %; and performing a second ion exchange in the glass article in an exchange bath that comprises between 0 wt % and 10 wt % of a sodium salt based on the total amount of salt, preferably sodium nitrate NaNO₃, over a duration of at least one hour and at most 6 hours, at a temperature of the exchange bath of at least 380° C. and at most 440° C., wherein a potassium salt is added to the exchange bath, most preferably potassium nitrate KNO₃, in particular such that the total contents of sodium salt and potassium salt add up to 100 wt %; and optionally one or more further ion exchange steps.

These further ion exchange steps may also be performed prior to the second ion exchange step.

The present disclosure furthermore relates to a glass article that is produced or producible by a method according to an embodiment and/or comprises a glass according to an embodiment.

### EXAMPLES

The invention will now be further explained by way of examples.

First, a base composition of a glass was specified. This base composition, still without colorants, generally comprises the following constituents, in mol % on an oxide basis:

| | |
|---|---|
| SiO₂ | 65 |
| Al₂O₃ | 11.5 |
| B₂O₃ | less than 1 |
| Li₂O | 10 |
| Na₂O | 9.3 |
| K₂O | less than 1 |
| MgO | less than 1 |
| CaO | — |
| ZnO | less than 1 |
| P₂O₅ | 0.5 |
| Fe₂O₃ | less than 0.1 |
| ZrO₂ | 1.8 |
| CeO₂ | less than 0.1. |

The color-imparting oxides that are added to this base composition were provided in the following proportions in the examples discussed below:

Example 1 (Co): 1 mol % of CoO

Example 2 (Fe—Ti+Co): 1.5 mol % of Fe₂O₃, 1 mol % of TiO₂, 0.2 mol % of CoO

Example 3 (Mn—Cr): 1.5 mol % of MnO, 0.4 mol % of Cr₂O.

The color-imparting constituents were added such that the relevant product properties (e.g., mechanical properties and toughenability) of the colored glass are changed as little as possible compared to the non-colored base glass according to the developer's assessment. Therefore, the glasses are not exactly made up of X % base glass+(100-X) color-imparting oxides. The compositions of the exemplary glasses are listed in the table below. All specifications are in mol %.

| | Example 1 | Example 2 | Example 3 |
|---|---|---|---|
| SiO₂ | 65.1 | 64.9 | 66.2 |
| Al₂O₃ | 11.5 | 11.1 | 11.4 |
| B₂O₃ | 0.0 | 0.0 | 0.0 |
| Li₂O | 10.6 | 10.6 | 10.5 |
| Na₂O | 9.3 | 9.3 | 9.2 |
| K2O | 0.3 | 0.3 | 0.4 |
| MgO | 0.0 | 0.7 | 0.0 |
| CaO | 0.0 | 0.0 | 0.0 |
| ZnO | 0.0 | 0.0 | 0.0 |
| P₂O₅ | 0.5 | 0.5 | 0.5 |
| Fe₂O₃ | 0.0 | 1.5 | 0.0 |
| ZrO₂ | 1.8 | 0.0 | 0.0 |
| CeO₂ | 0.0 | 0.0 | 0.0 |
| TiO₂ | 0.0 | 1.0 | 0.0 |
| CoO | 1.0 | 0.2 | 0.0 |
| Cr₂O₃ | 0.0 | 0.0 | 0.4 |
| MnO | 0.0 | 0.0 | 1.5 |

### BRIEF DESCRIPTION OF THE DRAWINGS

The invention will be explained in more detail below with reference to figures, wherein:

FIG. 1 is a schematic view, not true to scale, of a glass article according to one embodiment; and

FIG. 2 shows transmittance profiles of the three exemplary glasses.

### DETAILED DESCRIPTION

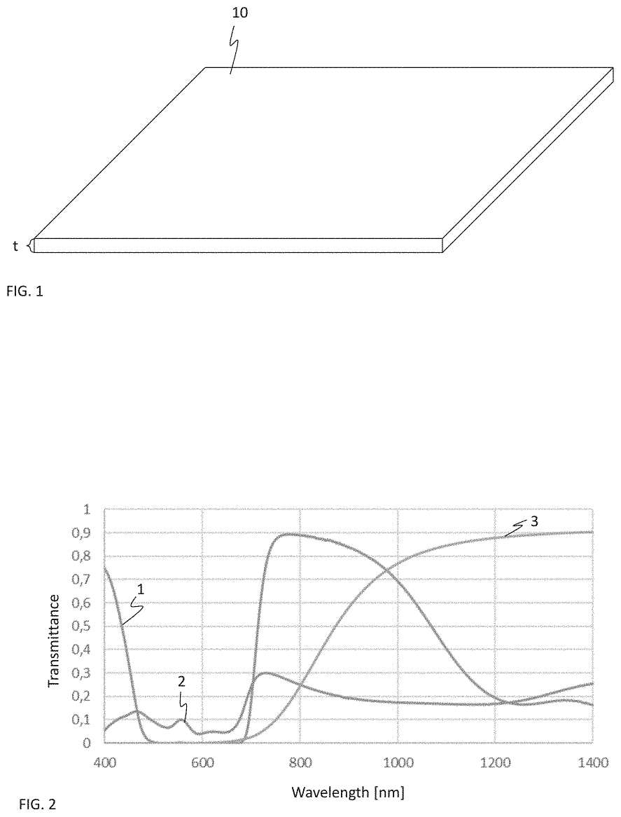

FIG. 1 shows, schematically and not true to scale, a sheet-like glass article 10 according to embodiments of the present disclosure. The sheet-like glass article 10 is flat here, but more generally, without being limited to a specific embodiment, it may also be curved or bent. The glass article 10 is sheet-like by virtue of having a thickness t that is smaller than the width and the length of the glass article. The length and width of the glass article define its faces (also referred to as main surfaces), namely the upper side and the lower side or, depending on the orientation of the glass article, the front and back sides.

FIG. 2 shows transmittance profiles for the three exemplary glasses listed in the table above. Transmittance profile 1 was obtained for exemplary glass 1, transmittance profile 2 for exemplary glass 2, and transmittance profile 3 for exemplary glass 3.

### LIST OF REFERENCE NUMERALS

10 Glass article
1, 2, 3 Transmittance profiles
t Thickness of 10

What is claimed is:

1. A chemically toughenable or toughened sheet-like glass article, comprising:
a glass with a composition comprising Al₂O₃, SiO₂, Li₂O, and Na₂O, wherein (Al₂O₃)−(Li₂O+Na₂O), in mol %, is less than 0;
a thickness between 0.3 mm and 4 mm;
a light transmittance of at least 0.001% to at most 60% at 450 nm, of at least 0.001% to at most 30% at 540 nm, and of at least 0.001% to at most 30% at 630 nm; and
an IR transmittance of at least 10% to not more than 99% at any wavelength in a wavelength range from 900 nm to 1100 nm,
wherein the light transmittance and the IR transmittance are determined for a thickness of the article of 1 mm.

2. The article of claim 1, wherein the composition further comprises K₂O and/or B₂O₃, and wherein (Al₂O₃+B₂O₃)−(Li₂O+Na₂O+K₂O), all in mol %, is less than 0.

3. The article of claim 1, further comprising at least 0.1 mol % and at most 5 mol % of at least one color-imparting component.

4. The article of claim 3, wherein the at least one color-imparting component is selected from a group consisting of CoO, Fe₂O₃, TiO₂, Cr₂O₃, MnO, and any mixtures thereof.

5. The article of claim 1, wherein the light transmittance is at least 0.1% at 450 nm, at 540 nm, and at 630 nm.

6. The article of claim 1, wherein:
the composition comprises 0.1 mol % to 2 mol % of CoO,
the light transmittance is at least 20% and up to at most 60% at 450 nm, at most 20% at 540 nm, and at most 20% at 630 nm, and
the IR transmittance of at least 20% from 900 nm to 1100 nm.

7. The article of claim 1, wherein the composition comprises 0.3 mol % to 1.5 mol % of CoO.

8. The article of claim 1, wherein:
the composition comprises 0.5 mol % to 5 mol % of Fe₂O₃ and 0.5 mol % to 3 mol % of TiO₂,
the light transmittance is at most 20% at 450 nm, at most 30% at 540 nm, and at most 30% at 630 nm, and
the IR transmittance is at least 10% from 900 nm to 1100 nm.

9. The article of claim 8, wherein the composition further comprises between 0.1 mol % and 1 mol % of CoO.

10. The article of claim 8, wherein the composition comprises between 1.5 mol % to 4 mol % of Fe₂O₃ and/or 1 mol % to 2.5 mol % of TiO₂.

11. The article of claim 1, wherein:
the composition comprises 0.1 mol % to 1 mol % of Cr₂O₃ and 0.5 mol % to 4 mol % of MnO,
the light transmittance is at most 10% at 450 nm, at most 20% at 540 nm, and at most 30% at 630 nm, and
the IR transmittance is at least 10% from 900 nm to 1100 nm.

12. The article of claim 11, wherein the composition comprises 0.2 mol % to 0.6 mol % of Cr₂O₃ and/or 1 mol % to 3 mol % of MnO.

13. The article of claim 1, further comprising a compressive stress (Cs) at a surface of the glass from at least 200 MPa to at most 1100 MPa, a compressive stress (Cs30) at a depth of 30 μm of at least 50 MPa up to 300 MPa, and a depth of compressive layer (DoCL) between 0.054 and 0.3*t, wherein t is the thickness of the glass in μm.

14. The article of claim 1, wherein the thickness is at least 0.3 mm, preferably at least 0.5 mm, and/or at most 2.5 mm, and preferably not more than 2 mm.

15. The article of claim 1, wherein the composition comprises, in mol %:

| | |
|---|---|
| SiO₂ | 60 to 70; |
| B₂O₃ | 0 to 7; |
| Al₂O₃ | 10 to 15; |
| Li₂O | 7 to 12; |
| Na₂O | 0.5 to 11; |
| K₂O | 0 to 1; |
| MgO | 0 to 5; |
| P₂O₅ | 0 to 3; and |
| ZrO₂ | 0 to 5. |

16. The article of claim 15, wherein the composition comprises, in mol %:

| | |
|---|---|
| SiO₂ | 63 to 68; |
| B₂O₃ | is not contained at all apart from impurities; |
| Al₂O₃ | 10 to 13; |
| Li₂O | 7 to 11; |
| Na₂O | 1 to 10; and |
| P₂O₅ | 0.2 to 2. |

17. The article of claim 1, wherein the glass is configured for a use selected from a group consisting of a back cover sheet for a display device, a back cover sheet for a computer screen, a back cover sheet for a measurement device, a back cover sheet for a television set, a back cover plate for a mobile terminal, a back cover plate for a mobile data processing device, a back cover plate for a mobile phone, a back cover plate for a mobile computer, a back cover plate for a palmtop, a back cover plate for a laptop, a back cover plate for a tablet computer, a back cover plate for a wearable device, a back cover plate for watch, and a back cover plate for a time measuring device.

18. A method for producing a toughened glass article (10) as claimed in any of claims 1 to 7, comprising the steps of
performing an ion exchange in the glass article (10) in an exchange bath that comprises between at least 10 wt % and up to 100 wt % of a sodium salt, preferably sodium nitrate NaNO₃, over a duration of at least 2 hours, preferably at least 4 hours, and not more than 24 hours, at a temperature between at least 380° C. and at most 440° C., wherein optionally a potassium salt can be added to the exchange bath, in particular potassium nitrate KNO₃, in particular such that the total contents of sodium salt and potassium salt add up to 100 wt %;
and performing a second ion exchange in the glass article (10) in an exchange bath that comprises between 0 wt % and 10 wt % of a sodium salt, preferably sodium nitrate NaNO₃, based on the total amount of salt, over a duration of at least one hour and at most 6 hours, at a temperature of the exchange bath of at least 380° C. and at most 440° C., wherein a potassium salt is added to the exchange bath, most preferably potassium nitrate KNO₃, in particular such that the total contents of sodium salt and potassium salt add up to 100 wt %;
and optionally one or more further ion exchange steps.
